(19) United States
(12) Patent Application Publication
(10) Pub. No.: US 2011/0024503 A1
(43) Pub. Date: Feb. 3, 2011

(54) ELECTRONIC DEVICE FOR WIRELESS TRANSMITTING

(75) Inventors: Xiang-Yu KONG, SHANGHAI CITY (CN); Yu ZHANG, SHANGHAI CITY (CN)

Correspondence Address: BRIAN M. MCINNIS, 12th Floor, Ruttonjee House, 11 Duddell Street, Hong Kong, HK

(73) Assignee: INVENTEC APPLIANCES CORP., TAIPEI HSIEN (TW)

(21) Appl. No.: 12/753,104

(22) Filed: Apr. 2, 2010

(30) Foreign Application Priority Data
Jul. 28, 2009 (TW) 98213833

(51) Int. Cl. G06K 7/06; G06K 19/07

(52) U.S. Cl. 235/441; 235/492

(57) ABSTRACT

An electronic device having a function of wireless transmission includes a wireless transceiving module, an accessing module and a shielding element that are disposed over a main board. The wireless transceiving module is used for transmitting a wireless signal. The accessing module is used for accessing an IC card having a radio frequency identification module. The shielding element is disposed between the wireless transceiving module and the accessing module and is electrically connected to a ground element of the main board. The shielding element is used for receiving the wireless signal to shield the radio frequency identification module.

### RELATED APPLICATIONS

This application claims priority to Taiwan Application Serial Number 98213833, filed Jul. 28, 2009, which is herein incorporated by reference.

### BACKGROUND

1. Field of Invention

The present invention relates to an electronic device. More particularly, the present invention relates to an electronic device for wireless transceiving.

2. Description of Related Art

Along with the development of technology, modern electronic devices are getting more and more powerful, and numerous functions are integrated into a single electronic device. Due to the demand for high stability of the electronic devices, it is now an important subject to maintain the operation quality of the electronic device while the internal disposition of the electronic device is getting more and more complex.

For example, the electromagnetic interference between different components decreases the operating stability of the electronic device. Especially in a small volume, highly integrated portable electronic device, the electromagnetic interference is more significant.

Taking a portable wireless card reader for example, the information stored in an IC card is acquired by the card reader and then is sent to a remote system through a wireless transmitting. However, the reading of the IC card is interfered by the wireless transmitting between the card reader and the remote system, and the interference leads to a problem like read error. Particularly, while reading an IC card that combines a short range radio communication component, the wireless signal between the card reader and the remote system couples to the antenna of the short range radio communication component. This coupling phenomenon can be regarded as interference to the IC card, and the interference further proceeds to the storage chip in the IC card through the internal circuit thereof. As a result, the IC card can not work normally, and the card reader can not acquire the information stored in the IC card properly.

### SUMMARY

An electronic device having a function of wireless transmission is provided. The electronic device includes a main board, a wireless transceiving module, an accessing module, a processing unit and a shielding element. The main board includes a ground element for connecting to a reference potential. The wireless transceiving module is disposed over the main board for transmitting a wireless signal. The accessing module is disposed over the main board for accessing an IC card when the IC card is electrically connected to the accessing module. The IC card has a radio frequency identification module. The processing unit is disposed over the main board and is electrically connected to the wireless transceiving module and the accessing module for controlling the wireless transceiving module and the accessing module. The shielding element is disposed over the main board and between the accessing module and the wireless transceiving module. The shielding element is electrically connected to the ground element for receiving the wireless signal to shield the radio frequency identification module of the IC card.

According to one embodiment of the invention, the shielding element includes a grounding metal plate.

According to another embodiment of the invention, the shielding element is in a form of an antenna layout and is electrically connected to the ground element.

According to another embodiment of the invention, the wireless transceiving module has a first operating frequency. The radio frequency identification module has a second operating frequency. The second operating frequency is lower than the first one.

According to another embodiment of the invention, the range of the first operating frequency is from about 380 MHz to about 1900 MHz.

According to a further embodiment of the invention, the second operating frequency is about 13.56 MHz.

According to another embodiment of the invention, the shielding element is has a width matching the wireless signal so that the shielding element serves as a receiving antenna for the wireless signal.

According to another embodiment of the invention, the shielding element has a resonance frequency that approximately equals the first operating frequency.

According to another embodiment of the invention, the shielding element has a shape matching the wireless signal so that the shielding element serves as a receiving antenna for the wireless signal.

According to another embodiment of the invention, the shielding element has a resonance frequency that approximately equals the first operating frequency.

According to another embodiment of the invention, an interval between the shielding element and the wireless transceiving module is greater than an interval between the shielding element and the accessing module.

According to yet another embodiment of the invention, the accessing module is used for accessing data stored in the IC card. The wireless transceiving module is used for transmitting the wireless signal having the stored data.

In the foregoing electronic device having a function of wireless transmission, the shielding element is disposed between the accessing module and the radio frequency identification module of the IC card. The shielding element receives the wireless signal to shield the radio frequency identification module. Thus the IC card can be accessed normally. The electronic device has the merits of simple structure and low cost, and there is no need to alter the design of the IC card.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective of an electronic device having a function of wireless transmission according to one embodiment of the invention;

FIG. 2 is a perspective of the IC card for inserting into the accessing module; and

FIG. 3 is a perspective of the electronic device of FIG. 1 with the inserted IC card.

### DETAILED DESCRIPTION

Reference will now be made in detail to the present embodiments of the invention, examples of which are illustrated in the accompanying drawings. Wherever possible, the same reference numbers are used in the drawings and the description to refer to the same parts.

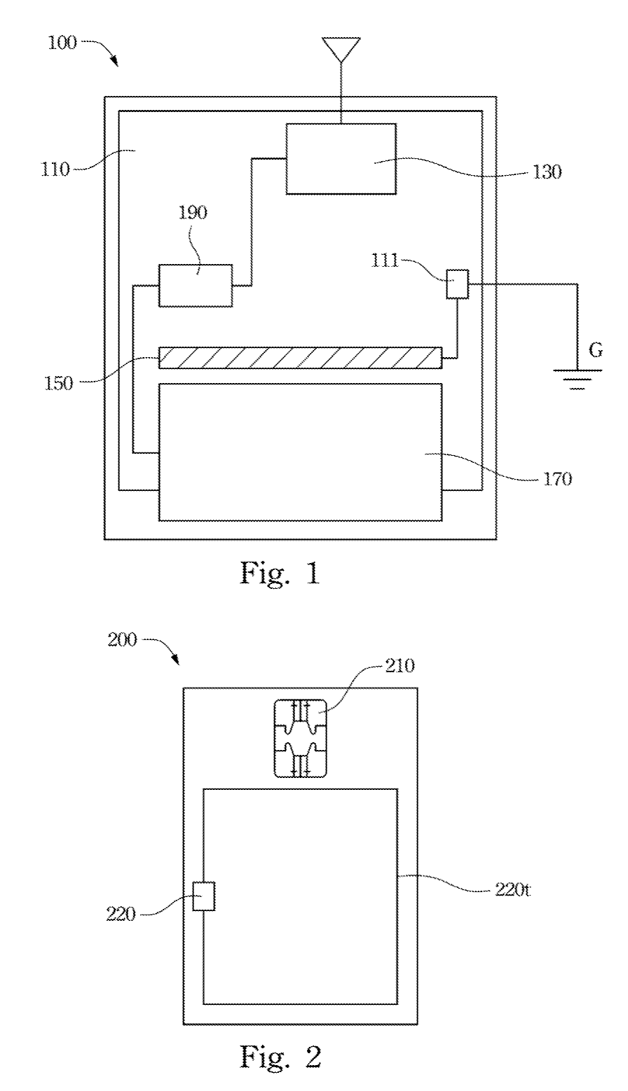

Please refer to FIG. 1. A perspective of an electronic device having the function of wireless transmission according to one embodiment of the invention is illustrated. The electronic device 100 includes a main board 110, a wireless transceiving module 130, a shielding element 150, an accessing module 170 and a processing unit 190. The wireless transceiving module 130 is disposed over the main board 110. An integrated-circuit (IC) card having a radio frequency identification module can be inserted into the accessing module 170 to be accessed by the accessing module 170. The processing unit 190 is disposed over the main board 110 and is electrically connected to the wireless transceiving module 130 and the accessing module 170 for controlling the wireless transceiving module 130 and the accessing module 170. The shielding element 150 is disposed over the main board 110 and between the wireless transceiving module 130 and the accessing module 170. The shielding element 150 is electrically connected to a ground element 111 of the main board 110. Thereby, the shielding element 150 is connected to a reference potential G for shielding the radio frequency identification module of the IC card.

Please refer to FIG. 2 at the same time. A perspective of the IC card for inserting into the accessing module is illustrated. The IC card 200 includes a storage chip 210 and the radio frequency identification module 220. The data, including user information or passwords for example, is stored in the storage chip 210. The radio frequency identification module 210 is exemplified by utilizing wireless identification technology to conduct identity recognition and data transceiving with a peripheral equipment through an antenna 220t, without establishing a mechanical or optical contact with the peripheral equipment.

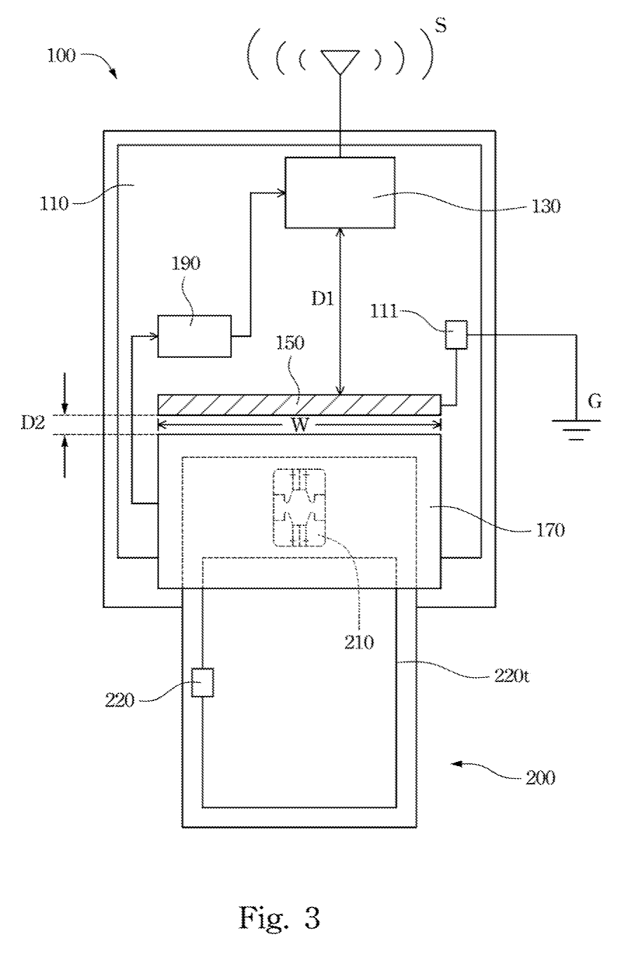

Please refer to FIG. 3. FIG. 3 shows a perspective of the electronic device of FIG. 1 with the inserted IC card. In one embodiment, the accessing module 170 includes an insertion slot for receiving the IC card 200. When the IC card 200 is inserted into the accessing module 170, the storage chip 210 is electrically connected to the accessing module 170. The electronic device 100 acquires the stored data in the storage chip 210 via the accessing module 170, and the stored data is then transmitted to the processing unit 190 of the electronic device 100. Afterwards, the stored data is further transmitted to the wireless transceiving module 130 by the processing unit 190, and is ready to be transmitted. The processing unit 190 controls the wireless transceiving module 130 to transmit the wireless signal S having the stored data. A remote system (not shown in the drawings) receives the stored data of the IC card 200 from the wireless signal S and then conducts operations like storing data, analyzing information and so on. Practically, the electronic device 100 for wireless transmitting can be exemplified by a portable card-swiping device or a point-of-sale management device.

Furthermore, the wireless transceiving module 130 has a first operating frequency, and the radio frequency identification module 220 has a second operating frequency. The first operating frequency is higher than the second one. In practical use, the wireless transceiving module 130 can be a global system for mobile communications (GSM) wireless transceiving module whose operating frequency ranges from about 380 MHz to about 1900 MHz. In fact, the operating frequency of the GSM wireless transceiving module can be about 380 MHz, about 410 MHz, about 450 MHz, about 480 MHz, about 710 MHz, about 750 MHz, about 810 MHz, about 850 MHz, about 900 MHz, about 1800 MHz, or about 1900 MHz. The word “about” means in a certain variation from the value of the operating frequency that the wireless transceiving module 130 still conforms to each frequency segment of the GSM specification and is still capable of communicating with the remote system.

On the other hand, the operating frequency of the radio frequency identification module 220 is about 13.56 MHz. In this regard, the wireless signal S sent by the wireless transceiving module 130 can be regarded as an electromagnetic interference to the radio frequency identification module 220.

In the electronic device 100, a part of the wireless signal S is transmitted toward the accessing module 170 from the wireless transceiving module 130. The shielding element 150, which is disposed between the accessing module 170 and the wireless transceiving module 130 and is electrically connected to the ground element 111, is used for receiving the part of the wireless signal S and then guiding it to the ground element 111. In one embodiment, the ground element 111 is exemplified by a ground circuit. In this manner, the coupling phenomenon of the wireless signal S to the antenna 220t of the radio frequency identification module 220 is avoided by the shielding element 150. As a result, by disposing the shielding element 150 between the accessing module 170 and the wireless transceiving module 130, the electronic device 100 can be free from problems such as abnormal accessing of the IC card 200 and interference on the IC card 200.

Practically, the shielding element 150 can be exemplified by a grounding metal plate. More specifically, the shielding element 150 is in a form of an antenna layout and is electrically connected to the ground element 111. The shielding element 150 has a width W or a shape matching the wireless signal S. Thus the shielding element 150 has a resonance frequency that approximately equals the wireless signal S. The length, the width W and the shape of the shielding element 150 are designed in accordance with the wavelength, the frequency or other characteristics of the wireless signal S. They are not limited to the shape of the stripe shown in FIG. 3. Other sizes and shapes, which match with the wireless signal S so that the shielding element 150 can receive the wireless signal S accordingly, can be used in the embodiment of the invention to reduce the interference acting on the antenna 220t of the radio frequency identification module 220.

The shielding element 150 is tailored and designed in accordance with the wireless signal S. It serves as an antenna for receiving the wireless signal S. From this point of view, the shielding element 150 has a first receiving ability for the wireless signal S. The radio frequency identification module 220 of the IC card 200 has a second receiving ability for the wireless signal S. The first receiving ability is greater than the second one. Therefore, the shielding element 150 can be used in the electronic device 100 to receive the wireless signal S that interferes the accessing of the IC card 200, and thus the IC card 200 is shielded and the electronic device 100 can properly access the stored data in the storage chip 210.

On the other hand, the shielding element 150 is disposed between the accessing module 170 and the wireless transceiving module 130. More specifically, the shielding element 150 is closer to the accessing module 170 than to the wireless transceiving module 130. As shown in FIG. 3, a first interval D1 between the shielding element 150 and the wireless transceiving module 130 is greater than a second interval D2 between the shielding element 150 and the accessing module 170. Due to the reason that the first interval D1 is greater than the second interval D2, the accessing module 170 therefore can be effectively shielded by the shielding element 150. Other shapes and dispositions of the shielding element 150 which make the resonance frequency of the shielding element 150 approximately equal the frequency of the wireless signal S can be eligible in the embodiment of the invention. The wireless signal S is received by the shielding element 150 and then is guided to the reference potential G.

In the above-described electronic device having the function of wireless transmitting, the IC card is shielded by way of receiving a part of the wireless signal by the shielding element. Therefore, the IC card is free from the interference of the wireless signal, and the stability of the electronic device of accessing the IC card is ensured. On the other hand, because the shielding element is disposed in the electronic device, not in the IC card, there is no need to alter the design of the IC card. Thus, the applicability of the electronic device is increased. Moreover, the structure of the shielding element is uncomplicated and the disposition of which is simple and convenient, so the structure of the electronic device is not significantly changed and the cost is inexpensive.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An electronic device having a function of wireless transmission, comprising:
a main board comprising a ground element for connection to a reference potential;
a wireless transceiving module disposed over the main board for transmitting a wireless signal;
an accessing module disposed over the main board for accessing an integrated-circuit (IC) card when the IC card is electrically connected to the accessing module, wherein the IC card has a radio frequency identification module;
a processing unit disposed over the main board and electrically connected to the wireless transceiving module and the accessing module for controlling the wireless transceiving module and the accessing module; and
a shielding element disposed over the main board and between the accessing module and the wireless transceiving module, wherein the shielding element is electrically connected to the ground element for receiving the wireless signal to shield the radio frequency identification module of the IC card.

2. The electronic device of claim 1, wherein the shielding element comprises a grounding metal plate.

3. The electronic device of claim 1, wherein the shielding element is in a form of an antenna layout and is electrically connected to the ground element.

4. The electronic device of claim 1, wherein the wireless transceiving module has a first operating frequency, and the radio frequency identification module has a second operating frequency lower than the first operating frequency.

5. The electronic device of claim 4, wherein the range of the first operating frequency is from about 380 MHz to about 1900 MHz.

6. The electronic device of claim 5, wherein the second operating frequency is about 13.56 MHz.

7. The electronic device of claim 4, wherein the wireless transceiving module comprises a global system for mobile communications (GSM) wireless transceiving module.

8. The electronic device of claim 4, wherein the shielding element has a width matching the wireless signal so that the shielding element serves as a receiving antenna for the wireless signal.

9. The electronic device of claim 8, wherein the shielding element has a resonance frequency that approximately equals the first operating frequency.

10. The electronic device of claim 4, wherein the shielding element has a shape matching the wireless signal so that the shielding element serves as a receiving antenna for the wireless signal.

11. The electronic device of claim 10, wherein the shielding element has a resonance frequency that approximately equals the first operating frequency.

12. The electronic device of claim 1, wherein an interval between the shielding element and the wireless transceiving module is greater than an interval between the shielding element and the accessing module.

13. The electronic device of claim 1, wherein the accessing module is used for accessing data stored in the IC card, and the wireless transceiving module is used for transmitting the wireless signal having the stored data.
